(19) United States
(12) Patent Application Publication
(10) Pub. No.: US 2026/0259541 A1
(43) Pub. Date: Sep. 3, 2026

(54) RECORDING MEDIUM, FA-CONTROL PROGRAM GENERATION SUPPORT DEVICE, AND FA-CONTROL PROGRAM GENERATION SUPPORT METHOD

(71) Applicant: Mitsubishi Electric Corporation, Tokyo (JP)

(72) Inventor: Shaoyang YAN, Tokyo (JP)

(73) Assignee: Mitsubishi Electric Corporation, Tokyo (JP)

(21) Appl. No.: 18/878,685

(22) PCT Filed: Dec. 14, 2022
(86) PCT No.: PCT/JP2022/046091

§ 371 Date: Dec. 24, 2024

(51) Int. Cl. G05B 19/05

(52) U.S. Cl. CPC G05B 19/056; G05B 2219/13004

(57) ABSTRACT

A first filter-condition acquirer in an FA-control program generation support device acquires first filter-condition data specified by a user. A first partial configuration-diagram generator generates first partial configuration-diagram data based on configuration-diagram data and the first filter-condition data. A first partial configuration-diagram display controller causes display of the first partial configuration-diagram data. A second filter-condition acquirer acquires second filter-condition data specified by the user. A second partial configuration-diagram generator generates second partial configuration-diagram data based on the first partial configuration-diagram data and the second filter-condition data. A second partial configuration-diagram display controller causes display of the second partial configuration-diagram data.

### TECHNICAL FIELD

The present disclosure relates to a factory automation (FA)-control program generation support program, an FA-control program generation support device, and an FA-control program generation support method.

### BACKGROUND ART

A known tool supports generation of FA-control programs executable by programmable logic controllers (PLCs) for controlling devices in FA. Such a tool provides projects for managing data to be used in an FA-control program generated by structured programming. Such a tool can also display a relationship diagram illustrating relationships between data items such as programs, function blocks (FBs), structures, and interfaces, as components included in a project. In addition, the tool may have the filtering function of selectively extracting relationships between specific components from the displayed relationship diagram.

An example device with the filtering function is a PLC development support device described in Patent Literature 1 including symbol addition means for receiving a user request to add a symbol to a specific design item among multiple design items, and display control means for displaying a list of such specific design items each with a symbol added by the symbol addition means.

### CITATION LIST

### Patent Literature

Patent Literature 1: Unexamined Japanese Patent Application Publication

### SUMMARY OF INVENTION

### Technical Problem

The device described in Patent Literature 1 can display, at a time, a list of multiple different design items with multiple different symbols, but cannot newly add symbols to the design items displayed in the list. More specifically, the device described in Patent Literature 1 can set multiple filter conditions at a time to acquire a filtering result, but cannot further use an additional filter condition for the acquired filtering result to update the filtering result. The device described in Patent Literature 1 thus cannot narrow down the search using the acquired filtering result. For a larger project, the device can less easily identify components associated with specific components in the project.

Under such circumstances, an objective of the present disclosure is to allow a user to more easily identify components associated with specific components.

### Solution to Problem

To achieve the above objective, an FA-control program generation support program according to an aspect of the present disclosure is a program for causing a computer to function as a component data acquirer, a configuration-diagram generator, a configuration-diagram display controller, a first filter-condition acquirer, a first partial configuration-diagram generator, a first partial configuration-diagram display controller, a second filter-condition acquirer, a second partial configuration-diagram generator, and a second partial configuration-diagram display controller. The component data acquirer acquires component data stored in a database for a project to manage data for an FA-control program. The component data is data about a component of the project. The FA-control program is a structured program executable by a programmable logic controller to control an FA device. The FA is factory automation. The configuration-diagram generator generates configuration-diagram data based on the component data. The configuration-diagram data indicates a configuration diagram of the project. The configuration-diagram display controller causes a display to display the configuration-diagram data. The first filter-condition acquirer acquires first filter-condition data. The first filter-condition data indicates a first specific component of the project specified by a user from the configuration-diagram data. The first partial configuration-diagram generator generates first partial configuration-diagram data based on the configuration-diagram data and the first filter-condition data. The first partial configuration-diagram data indicates a first partial configuration diagram being a part of the configuration diagram including the first specific component and a component associated with the first specific component. The first partial configuration-diagram display controller causes the display to display the first partial configuration-diagram data. The second filter-condition acquirer acquires second filter-condition data. The second filter-condition data indicates a second specific component of the project specified by the user from the first partial configuration-diagram data. The second partial configuration-diagram generator generates second partial configuration-diagram data based on the first partial configuration-diagram data and the second filter-condition data. The second partial configuration-diagram data indicates a second partial configuration diagram being a part of the first partial configuration diagram including the second specific component and a component associated with the second specific component. The second partial configuration-diagram display controller causes the display to display the second partial configuration-diagram data.

### Advantageous Effects of Invention

In the above aspect of the present disclosure, the computer generates, when the first specific component is specified by the user from the displayed configuration-diagram data, the first partial configuration-diagram data indicating the relationship between the first specific component and a component different from the first specific component, and displays the first partial configuration-diagram data. The computer then generates, when the second specific component is specified by the user from the displayed first partial configuration-diagram data, the second partial configuration-diagram data indicating the relationship between the second specific component and a component different from the second specific component, and displays the second partial configuration-diagram data. Thus, the FA-control program generation support program according to the above aspect of the present disclosure allows the user to more easily identify components associated with specific components than an FA-control program generation support program that does not allow the user to specify the second specific component from the first partial configuration-diagram data and than an FA-control program generation support program that does not generate or display the second partial configuration-diagram data when the second specific component is specified by the user.

### BRIEF DESCRIPTION OF DRAWINGS

FIG. 1 is a functional block diagram of an FA-control program generation support device according to an embodiment;

FIG. 2 is a block diagram of the FA-control program generation support device illustrating the hardware configuration;

FIG. 3 is a diagram of an example process for acquiring component data;

FIG. 4 is a diagram of an example process for analyzing components;

FIG. 5 is a diagram of an example process for generating configuration-diagram data;

FIG. 6 is a diagram of an example process for displaying the configuration-diagram data;

FIG. 7 is a diagram of an example process for displaying configuration-diagram data different from the configuration-diagram data in FIG. 6;

FIG. 8 is a diagram of an example process for displaying first filter-condition data;

FIG. 9 is a diagram of an example process for detecting a first specific component;

FIG. 10 is a diagram of an example process for acquiring the first filter-condition data;

FIG. 11 is a diagram of an example process for analyzing the first specific component;

FIG. 12 is a diagram of an example process for generating first partial configuration-diagram data;

FIG. 13 is a diagram of an example process for displaying the first partial configuration-diagram data;

FIG. 14 is a diagram of an example process for displaying second filter-condition data;

FIG. 15 is a diagram of an example process for detecting a second specific component;

FIG. 16 is a diagram of an example process for acquiring the second filter-condition data;

FIG. 17 is a diagram of an example process for analyzing the second specific component;

FIG. 18 is a diagram of an example process for generating second partial configuration-diagram data;

FIG. 19 is an example process for displaying the second partial configuration-diagram data;

FIG. 20 is a diagram of an example process for displaying a list of first filter conditions;

FIG. 21 is a diagram of an example process for displaying third partial configuration-diagram data;

FIG. 22 is a diagram of an example process for switching the display to the first partial configuration-diagram data corresponding to a selected first filter condition; and

FIG. 23 is a flowchart of an FA-control program generation support process.

### DESCRIPTION OF EMBODIMENTS

A factory automation (FA)-control program generation support program, an FA-control program generation support device, and an FA-control program generation support method according to one or more embodiments of the present disclosure are now described in detail with reference to the drawings. Like reference signs denote like or corresponding components in the drawings.

### FA-Control Program Generation Support Device 100

An FA-control program generation support device 100 according to one or more embodiments of the present disclosure is an example computer on which an FA-control program generation support program is installed for supporting FA-control program generation. The FA-control program is a structured program executable by a PLC for controlling FA devices. More specifically, the FA-control program generation support device 100 is a personal computer (referred to as an engineering tool) on which software for an engineering tool is installed.

The FA-control program generation support device 100 acquires data about components of a project from a project database for managing data for an FA-control program, analyzes the relationship between the components, and generates and displays the configuration diagram for the project. When a component is specified by a user from the displayed configuration diagram, the FA-control program generation support device 100 displays a filter condition indicating the component, acquires the resultant data, analyzes the relationship between the specified component and another component, and generates and displays a partial configuration diagram. This allows the user to identify any other component associated with the specific component.

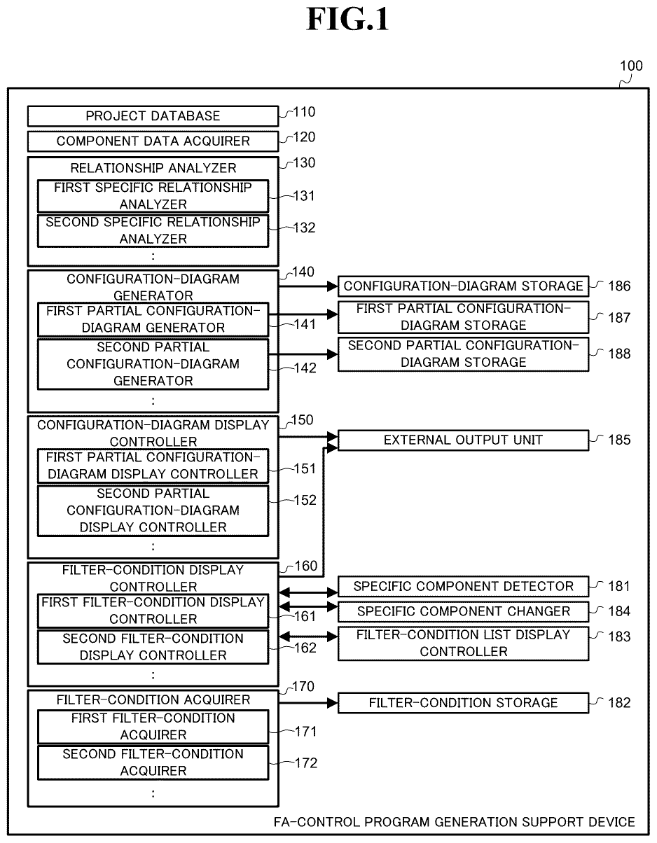

As illustrated in FIG. 1, the FA-control program generation support device 100 includes a project database 110 for the project described above. The FA-control program generation support device 100 also includes a component data acquirer 120 that acquires component data about the components described above from the project database 110 and a relationship analyzer 130 that analyzes the relationship between the components. The FA-control program generation support device 100 also includes a configuration-diagram generator 140 that generates configuration-diagram data indicating the configuration diagram described above, and a configuration-diagram display controller 150 that causes display of the configuration-diagram data. The FA-control program generation support device 100 also includes a filter-condition display controller 160 that causes display of filter-condition data indicating a specific component specified by the user, and a filter-condition acquirer 170 that acquires the filter-condition data.

The relationship analyzer 130 includes a first specific relationship analyzer 131 that analyzes the relationship between a first specific component (described later) and another component, and a second specific relationship analyzer 132 that analyzes the relationship between a second specific component (described later) and another component. The configuration-diagram generator 140 includes a first partial configuration-diagram generator 141 that generates first partial configuration-diagram data indicating a first partial configuration diagram (described later), and a second partial configuration-diagram generator 142 that generates second partial configuration-diagram data indicating a second partial configuration diagram (described later).

The configuration-diagram display controller 150 includes a first partial configuration-diagram display controller 151 that causes display of the first partial configuration-diagram data and a second partial configuration-diagram display controller 152 that causes display of the second partial configuration-diagram data. The filter-condition display controller 160 includes a first filter-condition display controller 161 that causes display of first filter-condition data (described later), and a second filter-condition display controller 162 that causes display of second filter-condition data (described later). The filter-condition acquirer 170 includes a first filter-condition acquirer 171 that acquires the first filter-condition data and a second filter-condition acquirer 172 that acquires the second filter-condition data.

The FA-control program generation support device 100 also includes a specific component detector 181 that detects a specific component, a filter-condition storage 182 that stores filter-condition data, and a filter-condition list display controller 183 that causes display of a list of filter-condition data. The FA-control program generation support device 100 also includes a specific component changer 184 that changes specific components, and an external output unit 185 that externally outputs data. The FA-control program generation support device 100 also includes a configuration-diagram storage 186 that stores the configuration-diagram data, a first partial configuration-diagram storage 187 that stores the first partial configuration-diagram data, and a second partial configuration-diagram storage 188 that stores the second partial configuration-diagram data.

### Hardware Configuration of FA-Control Program Generation Support Device 100

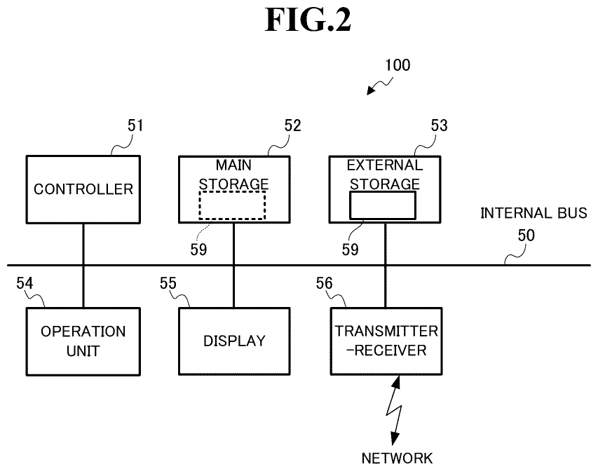

As illustrated in FIG. 2, the FA-control program generation support device 100 includes a controller 51 that performs processing based on a control program 59. The controller 51 includes a central processing unit (CPU). The controller 51 functions as, based on the control program 59, the component data acquirer 120, the relationship analyzer 130, the first specific relationship analyzer 131, the second specific relationship analyzer 132, the configuration-diagram generator 140, the first partial configuration-diagram generator 141, the second partial configuration-diagram generator 142, the configuration-diagram display controller 150, the first partial configuration-diagram display controller 151, the second partial configuration-diagram display controller 152, the filter-condition display controller 160, the first filter-condition display controller 161, the second filter-condition display controller 162, the filter-condition acquirer 170, the first filter-condition acquirer 171, the second filter-condition acquirer 172, the specific component detector 181, the filter-condition list display controller 183, and the specific component changer 184 illustrated in FIG. 1.

Referring back to FIG. 2, the FA-control program generation support device 100 loads the control program 59. The FA-control program generation support device 100 includes a main storage 52 used as a work area for the controller 51. The main storage 52 includes a random-access memory (RAM).

The FA-control program generation support device 100 also includes an external storage 53 prestoring the control program 59. The external storage 53 provides data stored in the program to the controller 51 as instructed by the controller 51, and stores data provided from the controller 51. The external storage 53 includes a nonvolatile memory such as a flash memory, a hard disk drive (HDD), or a solid state drive (SSD). The external storage 53 functions as the project database 110, the filter-condition storage 182, the configuration-diagram storage 186, the first partial configuration-diagram storage 187, and the second partial configuration-diagram storage 188 illustrated in FIG. 1.

Referring back to FIG. 2, the FA-control program generation support device 100 includes an operation unit 54 operable by the user. Information input with the operation unit 54 is provided to the controller 51. The operation unit 54 includes information input components such as a keyboard, a mouse, and a touchscreen.

The FA-control program generation support device 100 also includes a display 55 that displays information input with the operation unit 54 and information output from the controller 51. The display 55 includes a display device such as a liquid crystal display (LCD) or an organic electro-luminescent (EL) display.

The FA-control program generation support device 100 also includes a transmitter-receiver 56 that transmits and receives information. The transmitter-receiver 56 includes information communication components, such as a communication network termination device or a wireless communication device connected to a network. The transmitter-receiver 56 functions as the external output unit 185 illustrated in FIG. 1.

Referring back to FIG. 2, the FA-control program generation support device 100 includes the main storage 52, the external storage 53, the operation unit 54, the display 55, and the transmitter-receiver 56 that are all connected to the controller 51 with an internal bus 50.

The FA-control program generation support device 100 implements the functions of the components 110, 120, 130 to 132, 140 to 142, 150 to 152, 160 to 162, 170 to 172, and 181 to 188 illustrated in FIG. 1 with the controller 51 using the main storage 52, the external storage 53, the operation unit 54, the display 55, and the transmitter-receiver 56 as resources. For example, the FA-control program generation support device 100 performs a project storing process with the project database 110 and a component data acquiring process with the component data acquirer 120.

For example, the FA-control program generation support device 100 performs a relationship analysis process with the relationship analyzer 130, a first specific relationship analysis process with the first specific relationship analyzer 131, and a second specific relationship analysis process with the second specific relationship analyzer 132. For example, the FA-control program generation support device 100 performs a configuration-diagram generation process with the configuration-diagram generator 140, a first partial configuration-diagram generation process with the first partial configuration-diagram generator 141, and a second partial configuration-diagram generation process with the second partial configuration-diagram generator 142. For example, the FA-control program generation support device 100 performs a configuration-diagram display control process with the configuration-diagram display controller 150, a first partial configuration-diagram display control process with the first partial configuration-diagram display controller 151, and a second partial configuration-diagram display control process with the second partial configuration-diagram display controller 152.

For example, the FA-control program generation support device 100 performs a filter-condition display control process with the filter-condition display controller 160, a first filter-condition display control process with the first filter-condition display controller 161, and a second filter-condition display control process with the second filter-condition display controller 162. For example, the FA-control program generation support device 100 performs a filter-condition acquiring process with the filter-condition acquirer 170, a first filter-condition acquiring process with the first filter-condition acquirer 171, and a second filter-condition acquiring process with the second filter-condition acquirer 172.

For example, the FA-control program generation support device 100 performs a specific component detection process with the specific component detector 181. For example, the FA-control program generation support device 100 performs a filter-condition data storing process with the filter-condition storage 182 and a filter-condition data list display control process with the filter-condition list display controller 183. For example, the FA-control program generation support device 100 performs a specific component change process with the specific component changer 184 and an external output process with the external output unit 185. For example, the FA-control program generation support device 100 performs a configuration-diagram storing process with the configuration-diagram storage 186, a first partial configuration-diagram storing process with the first partial configuration-diagram storage 187, and a second partial configuration-diagram storing process with the second partial configuration-diagram storage 188.

### Details of Functional Configuration of FA-Control Program Generation Support Device 100

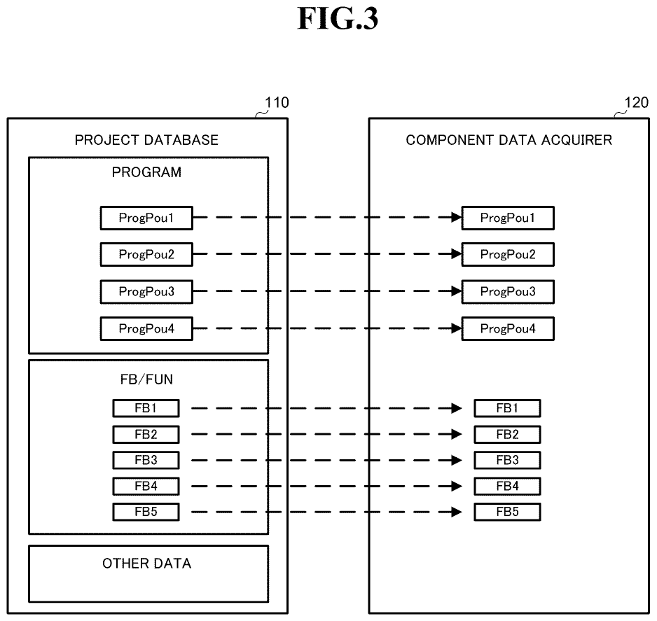

As illustrated in FIG. 3, the project database 110 stores component data for the project including data of programs, data of function blocks and functions, and other data. For example, the project database 110 stores a first program ProgPou1, a second program ProgPou2, . . . , a fourth program ProgPou4 each as component data of a program. For example, the project database 110 stores a first function block FB1, a second function block FB2, . . . , a fifth function block FB5 each as component data of a function block.

As illustrated in FIG. 3, the component data acquirer 120 acquires, from the project database 110, at least component data items ProgPou1 to ProgPou4 of the program and component data items FB1 to FB5 of the function block.

The relationship analyzer 130 analyzes the dependencies between the component data items ProgPou1 to ProgPou4 and FB1 to FB5 based on the component data items ProgPou1 to ProgPou4 and FB1 to FB5 acquired by the component data acquirer 120.

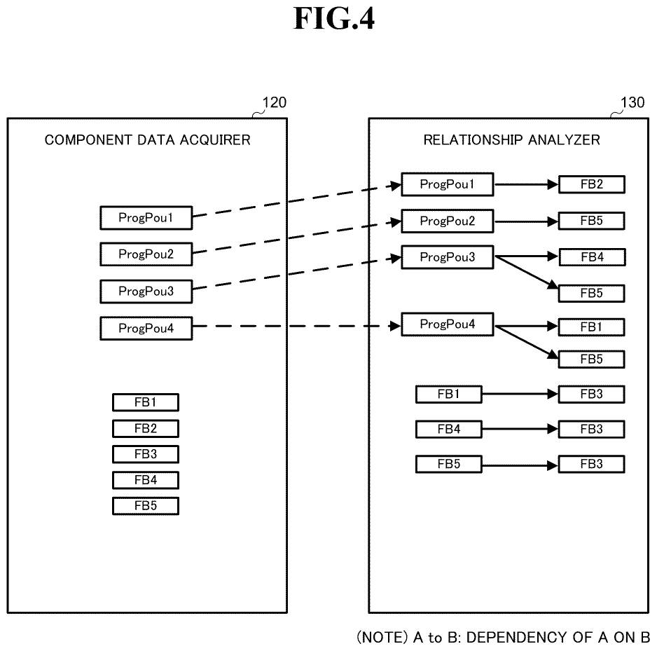

As illustrated in, for example, FIG. 4, the relationship analyzer 130 identifies the dependency of the first program ProgPou1 on the second function block FB2 and the dependency of the second program ProgPou2 on the fifth function block FB5. For example, the relationship analyzer 130 identifies the dependency of the third program ProgPou3 on the fourth function block FB4 and on the fifth function block FB5. For example, the relationship analyzer 130 identifies the dependency of the fourth program ProgPou4 on the first function block FB1 and on the fifth function block FB5. For example, the relationship analyzer 130 identifies the dependency of the first function block FB1, the fourth function block FB4, and the fifth function block FB5 on the third function block FB3.

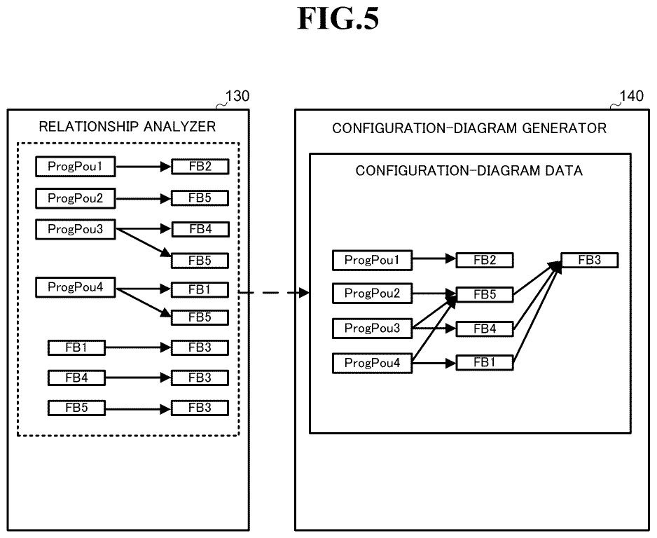

The configuration-diagram generator 140 generates configuration-diagram data based on the analysis results from the relationship analyzer 130. As illustrated in FIG. 5, the configuration-diagram generator 140 generates, as the configuration-diagram data, data indicating a configuration diagram including the dependency of the component data items ProgPou1 to ProgPou4 and FB1 to FB5 identified by the relationship analyzer 130, and stores the generated data into the configuration-diagram storage 186.

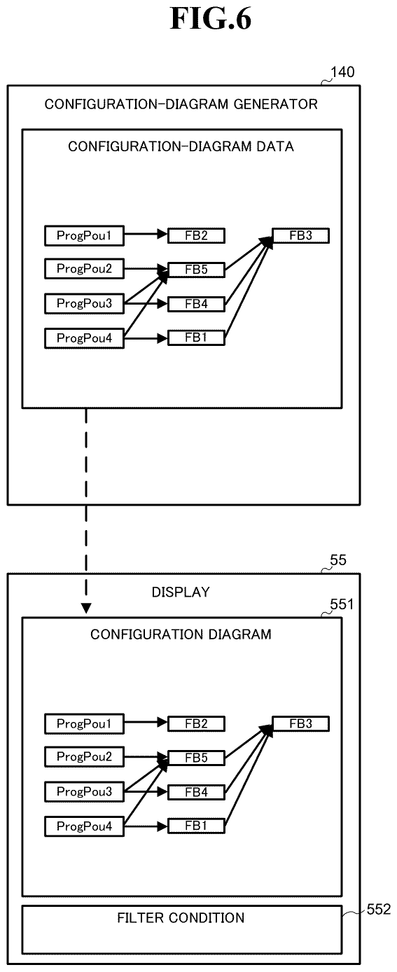

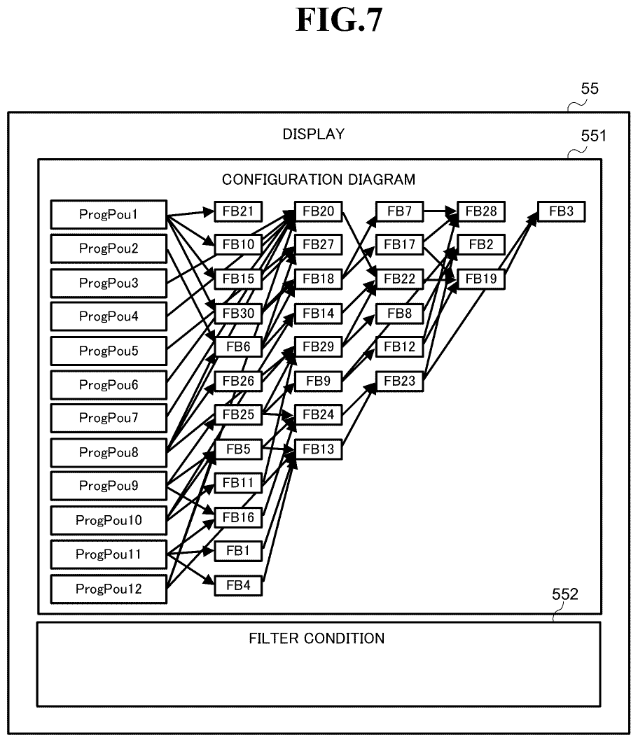

As illustrated in FIG. 6, the configuration-diagram display controller 150 causes the display 55 to display, in a configuration-diagram display area 551, the configuration-diagram data generated by the configuration-diagram generator 140. As illustrated in FIG. 7, the configuration-diagram display controller 150 may cause, in the configuration-diagram display area 551, display of the configuration-diagram data for a project larger than the configuration-diagram data illustrated in FIG. 6.

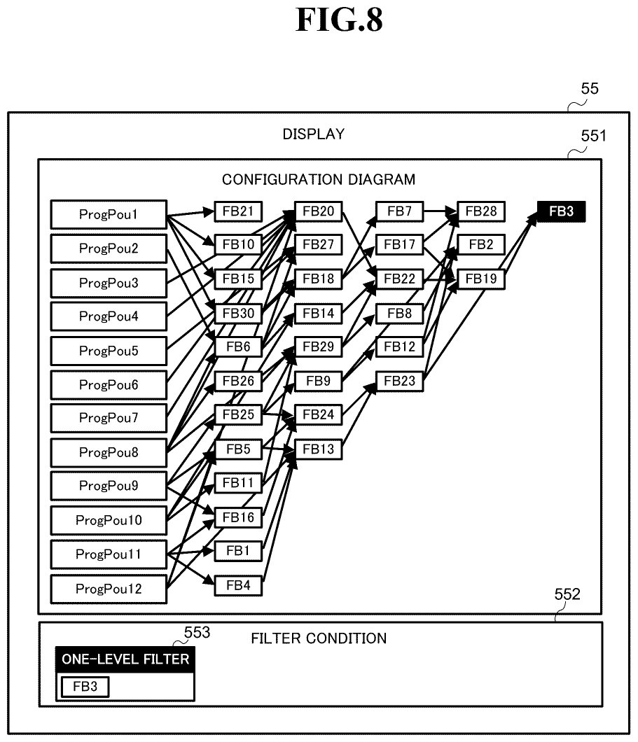

The filter-condition display controller 160 causes the display 55 to display, in a filter-condition display area 552, filter-condition data indicating a specific component of the project specified by the user from the configuration-diagram data displayed as controlled by the configuration-diagram display controller 150. The first filter-condition display controller 161 causes display of the first filter-condition data indicating the first specific component of the specific component specified by the user from the configuration-diagram data in a first filter-condition display area 553 in the filter-condition display area 552. As illustrated in, for example, FIG. 8, when the user selects the third function block FB3 from the configuration-diagram data in the configuration-diagram display area 551 with the operation unit 54, the first filter-condition display controller 161 causes display of the first filter-condition data indicating that the first specific component is the third function block FB3 in the first filter-condition display area 553.

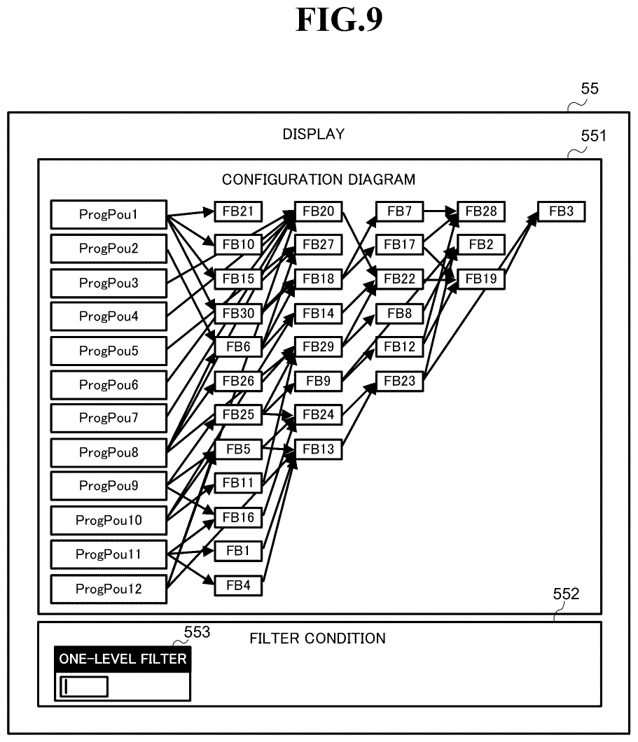

When the configuration-diagram data is displayed, the specific component detector 181 detects the first specific component based on text data input by the user. For example, when the user inputs text data into the first filter-condition display area 553 with the operation unit 54 as illustrated in FIG. 9, the specific component detector 181 detects the corresponding component data including the input text data from the component data displayed in the configuration-diagram display area 551. More specifically, when the user inputs text data FB3 indicating the third function block FB3, the specific component detector 181 detects the third function block FB3 from the component data displayed in the configuration-diagram display area 551. In this case, the first filter-condition display controller 161 causes display of the input text data in the first filter-condition display area 553 as first filter-condition data indicating that the first specific component is the third function block FB3 detected by the specific component detector 181.

When the first filter-condition data is displayed, the specific component changer 184 changes the first specific component based on data input by the user. For example, when the user operates the operation unit 54 to change the text data displayed in the first filter-condition display area 553 as described above, the specific component changer 184 changes the first specific component by detecting, with the specific component detector 181, the component data including the text data changed from the component data displayed in the configuration-diagram display area 551. More specifically, when the user changes the text data FB3 to text data FB2, the first specific component is changed from the third function block FB3 to the second function block FB2. When, for example, the user selects the component data displayed in the configuration-diagram display area 551 with the operation unit 54 in the above example, the specific component changer 184 changes the first specific component to a first specific component specified with the component data. In this case, the first filter-condition display controller 161 causes display of the first filter-condition data indicating the changed first specific component in the first filter-condition display area 553.

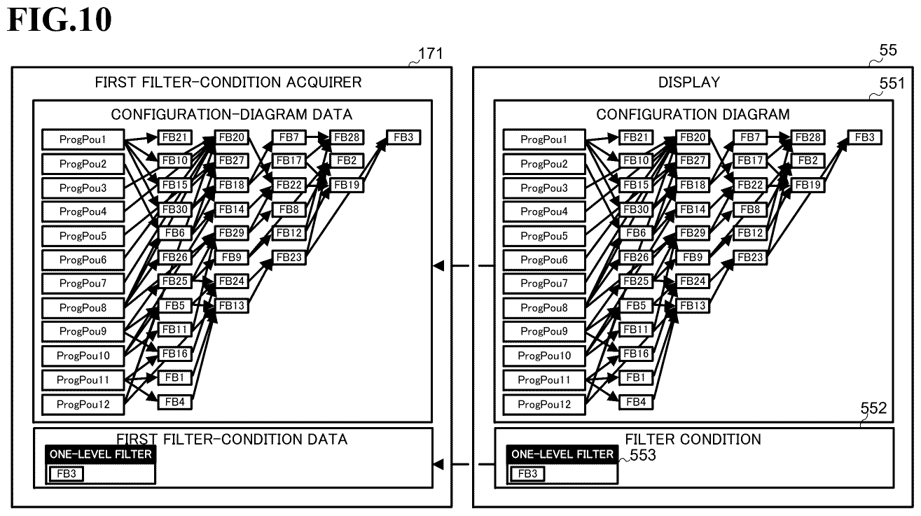

The filter-condition acquirer 170 acquires filter-condition data displayed in the filter-condition display area 552 displayed as controlled by the filter-condition display controller 160. As illustrated in FIG. 10, the first filter-condition acquirer 171 acquires the first filter-condition data displayed in the first filter-condition display area 553 displayed as controlled by the first filter-condition display controller 161, together with the configuration-diagram data displayed in the configuration-diagram display area 551 displayed as controlled by the configuration-diagram display controller 150, and stores the first filter-condition data into the filter-condition storage 182.

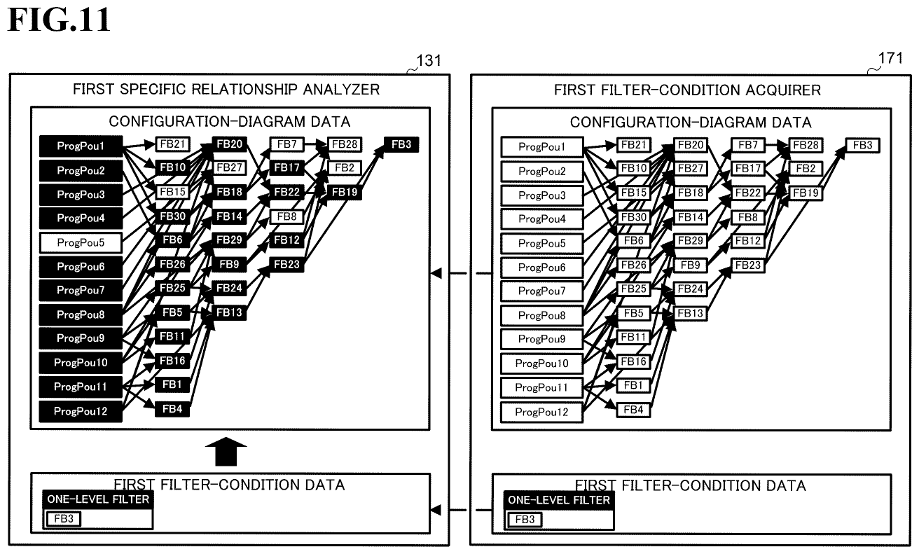

The first specific relationship analyzer 131 analyzes the relationship between the first specific component and another component different from the first specific component based on the first filter-condition data and the configuration-diagram data acquired by the first filter-condition acquirer 171. As illustrated in, for example, FIG. 11, the first specific relationship analyzer 131 analyzes all dependencies associated with the third function block FB3 as the first specific component, among the dependencies between the component data items ProgPou1 to ProgPou12 and FB1 to FB30. More specifically, the first specific relationship analyzer 131 identifies the dependency of the nineteenth function block FB19 and the twenty-third function block FB23 on the third function block FB3. The first specific relationship analyzer 131 also identifies, for example, the dependency of the seventeenth function block FB17, the twenty-second function block FB22, and the twelfth function block FB12 on the nineteenth function block FB19, and the dependency of the twenty-fourth function block FB24 and the thirteenth function block FB13 on the twenty-third function block FB23.

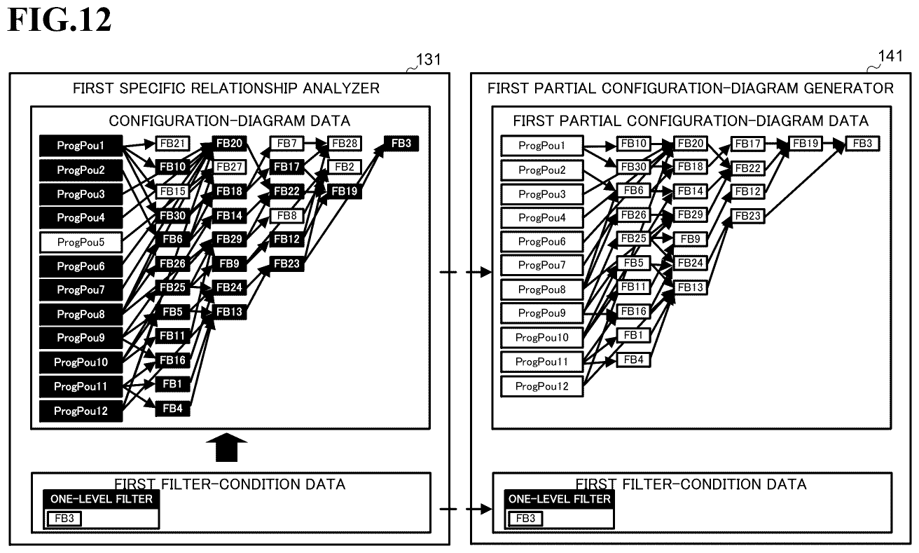

The first partial configuration-diagram generator 141 generates, based on the analysis results from the first specific relationship analyzer 131, the first partial configuration-diagram data indicating a first partial configuration diagram that is a part of the configuration diagram including the first specific component and a component associated with the first specific component. As illustrated in, for example, FIG. 12, the first partial configuration-diagram generator 141 generates, as the first partial configuration-diagram data, data indicating the first partial configuration diagram including all dependencies associated with the third function block FB3 as the first specific component identified by the first specific relationship analyzer 131, and stores the generated data into the first partial configuration-diagram storage 187. The first partial configuration-diagram storage 187 stores the first partial configuration-diagram data in a manner associated with the first filter-condition data stored in the filter-condition storage 182.

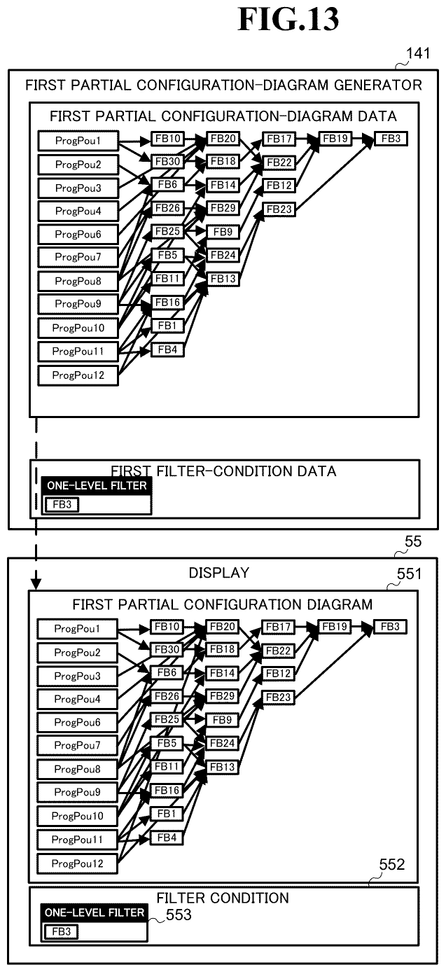

As illustrated in FIG. 13, the first partial configuration-diagram display controller 151 causes display of the first partial configuration-diagram data generated by the first partial configuration-diagram generator 141 in the configuration-diagram display area 551.

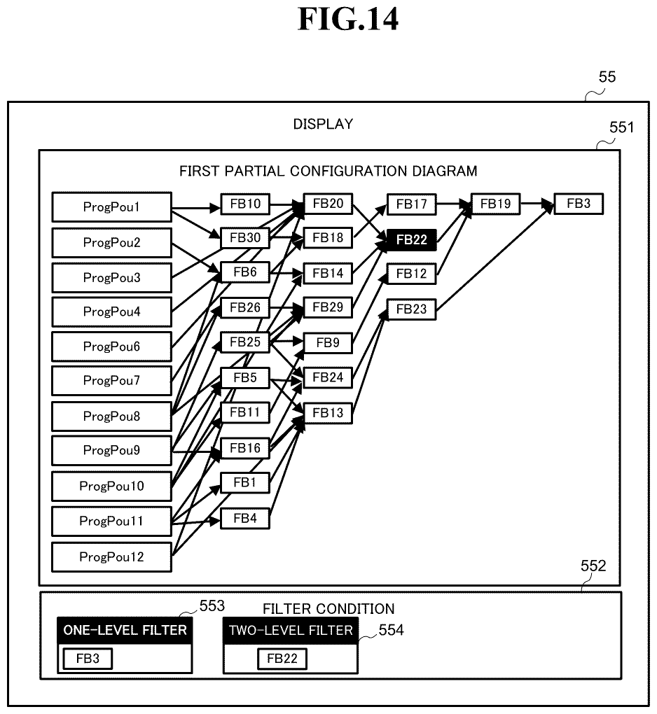

The second filter-condition display controller 162 causes display of the second filter-condition data indicating the second specific component of the specific component specified by the user from the first partial configuration-diagram data in a second filter-condition display area 554 in the filter-condition display area 552. As illustrated in, for example, FIG. 14, when the user selects the twenty-second function block FB22 from the first partial configuration-diagram data in the configuration-diagram display area 551 with the operation unit 54, the second filter-condition display controller 162 causes display of the second filter-condition data indicating that the second specific component is the twenty-second function block FB22 in the second filter-condition display area 554.

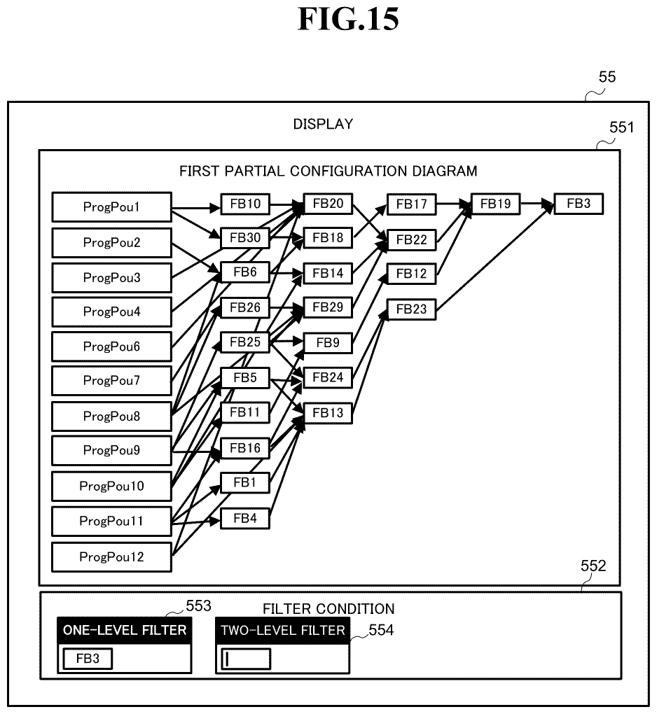

When the first partial configuration-diagram data is displayed, the specific component detector 181 detects the second specific component based on text data input by the user. For example, when the user inputs text data into the second filter-condition display area 554 with the operation unit 54 as illustrated in FIG. 15, the specific component detector 181 detects component data including the input text data from the component data displayed in the configuration-diagram display area 551 in the same manner as when the text data is input into the first filter-condition display area 553.

The specific component changer 184 also changes the second specific component based on data input by the user when the second filter-condition data is displayed. For example, when the user operates the operation unit 54 to change the text data displayed in the second filter-condition display area 554 as described above, the specific component changer 184 changes the second specific component by detecting, with the specific component detector 181, the component data including the text data changed from the component data displayed in the configuration-diagram display area 551 in the same manner as when the text data displayed in the first filter-condition display area 553 is changed. When, for example, the user selects the component data displayed in the configuration-diagram display area 551 with the operation unit 54 in the above example, the specific component changer 184 changes the second specific component to a second specific component specified with the component data. In this case, the second filter-condition display controller 162 causes display of the second filter-condition data indicating the changed second specific component in the second filter-condition display area 554.

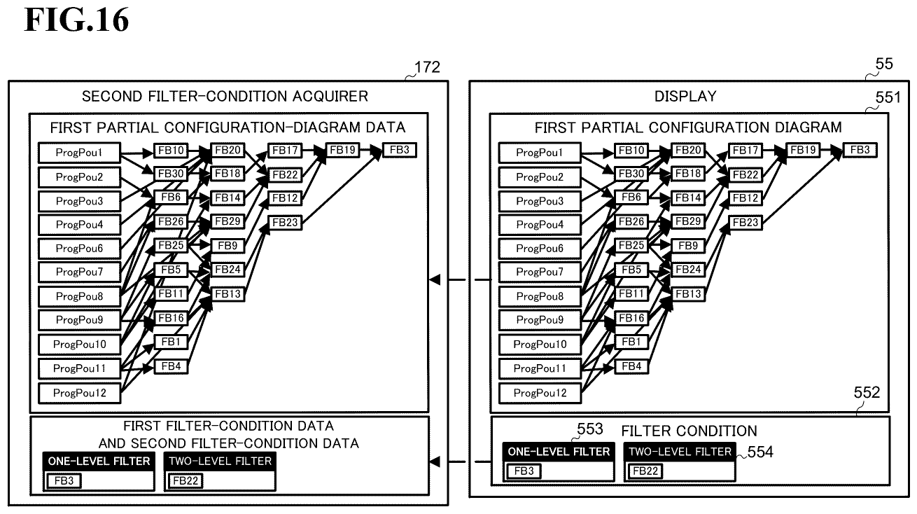

As illustrated in FIG. 16, the second filter-condition acquirer 172 acquires the second filter-condition data displayed in the second filter-condition display area 554 displayed as controlled by the second filter-condition display controller 162, together with the first partial configuration-diagram data displayed in the configuration-diagram display area 551 displayed as controlled by the first partial configuration-diagram display controller 151, and stores the second filter-condition data into the filter-condition storage 182.

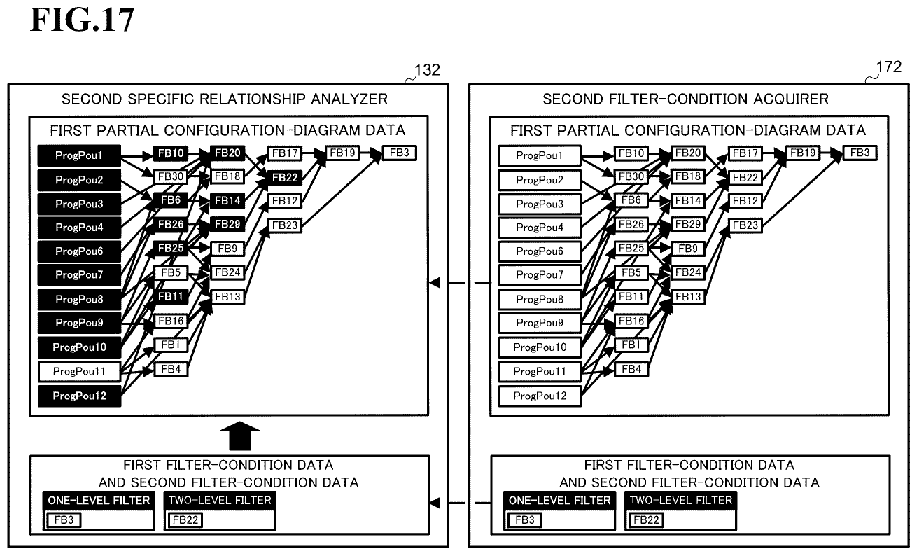

The second specific relationship analyzer 132 analyzes the relationship between the second specific component and another component different from the second specific component based on the second filter-condition data and the first partial configuration-diagram data acquired by the second filter-condition acquirer 172. As illustrated in, for example, FIG. 17, the second specific relationship analyzer 132 analyzes all dependencies associated with the twenty-second function block FB22 as the second specific component, among the dependencies between the component data items ProgPou1 to ProgPou4, ProgPou6 to ProgPou10, ProgPou12, FB1, FB3 to FB6, FB9 to FB14, FB16 to FB20, FB22 to FB26, FB29, and FB30. More specifically, the second specific relationship analyzer 132 identifies the dependency of the twentieth function block FB20, the fourteenth function block FB14, and the twenty-ninth function block FB29 on the twenty-second function block FB22. The second specific relationship analyzer 132 also identifies, for example, the dependency of the sixth function block FB6 on the fourteenth function block FB14, and the dependency of the twenty-sixth function block FB26, the twenty-fifth function block FB25, the eleventh function block FB11, and the eighth program ProgPou8 on the twenty-ninth function block FB29.

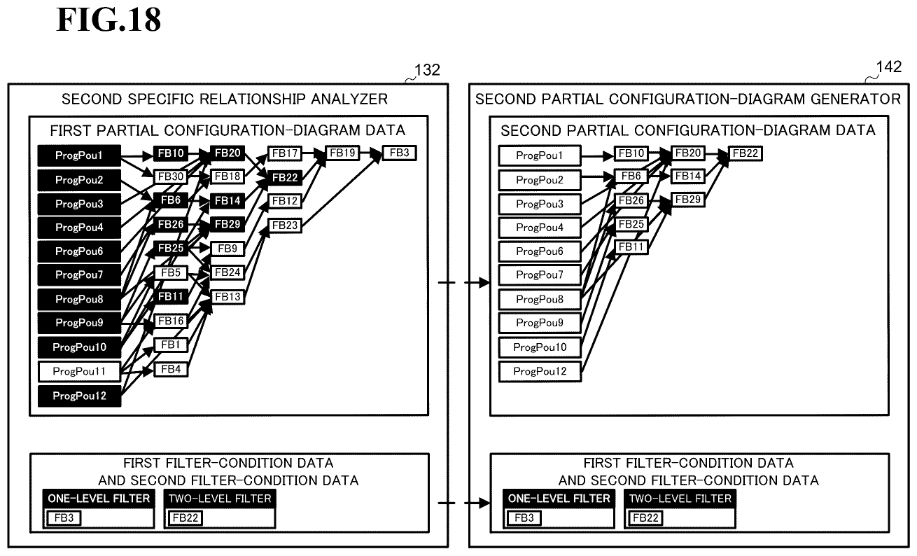

The second partial configuration-diagram generator 142 generates, based on the analysis results from the second specific relationship analyzer 132, the second partial configuration-diagram data indicating a second partial configuration diagram that is a part of the first partial configuration diagram including the second specific component and a component associated with the second specific component. As illustrated in, for example, FIG. 18, the second partial configuration-diagram generator 142 generates, as the second partial configuration-diagram data, data indicating the second partial configuration diagram including all dependencies associated with the twenty-second function block FB22 as the second specific component identified by the second specific relationship analyzer 132, and stores the generated data into the second partial configuration-diagram storage 188. The second partial configuration-diagram storage 188 stores the second partial configuration-diagram data in a manner associated with first filter-condition data and second filter-condition data stored in the filter-condition storage 182.

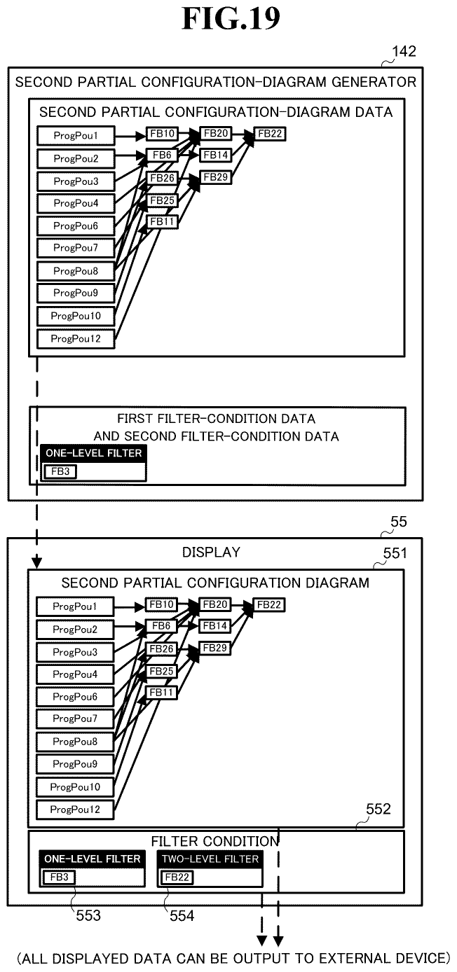

As illustrated in FIG. 19, the second partial configuration-diagram display controller 152 causes display of the second partial configuration-diagram data generated by the second partial configuration-diagram generator 142 in the configuration-diagram display area 551.

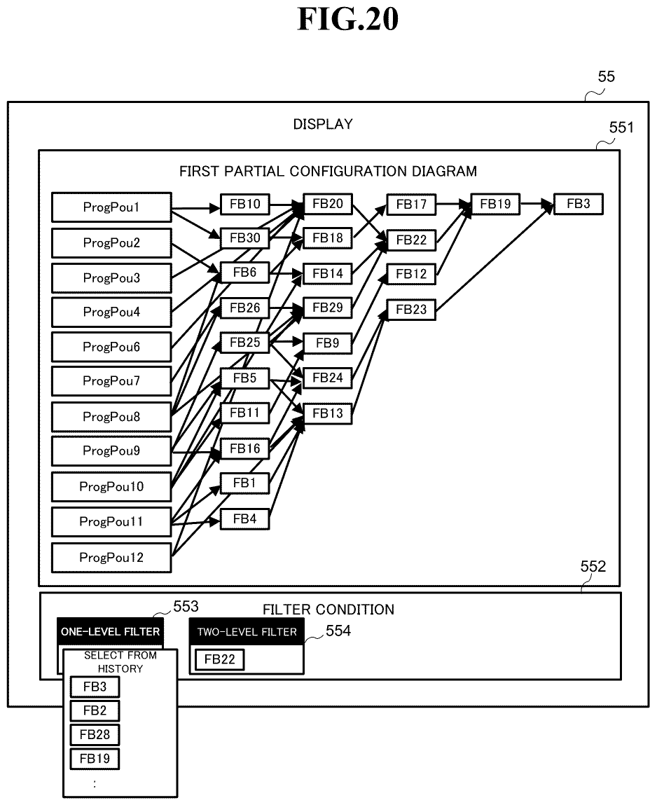

The filter-condition list display controller 183 causes the display 55 to display a list of filter-condition data stored in the filter-condition storage 182. As illustrated in, for example, FIG. 20, when a predetermined operation is performed by the user using the operation unit 54 in the first filter-condition display area 553, the filter-condition list display controller 183 causes display of a pulldown menu screen to display the list of all the first filter conditions stored in the filter-condition storage 182 on the menu screen. Although not illustrated, the filter-condition list display controller 183 also causes display of a menu screen when a predetermined operation is performed by the user in the second filter-condition display area 554 to display the list of all the second filter conditions stored in the filter-condition storage 182 on the menu screen.

The user can use the operation unit 54 to select a filter condition from the list of filter conditions displayed on the menu screen. In this case, the first filter-condition display controller 161 causes display of the first filter-condition data selected by the user in the first filter-condition display area 553. The second filter-condition display controller 162 causes display of the second filter-condition data selected by the user in the second filter-condition display area 554.

The external output unit 185 externally outputs data displayed on the display 55. As illustrated in, for example, FIG. 19, when the display 55 displays the second partial configuration-diagram data, the first filter-condition data, and the second filter-condition data, the user performs an external output operation with the operation unit 54 to output the data to an external terminal connected to the FA-control program generation support device 100 through a network allowing data transmission and reception.

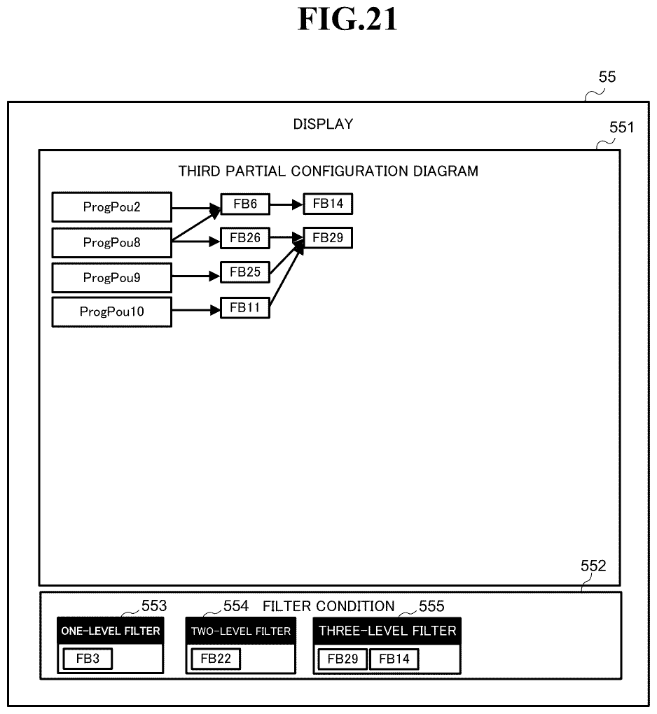

As illustrated in FIG. 21, in the FA-control program generation support device 100, the filter-condition display controller 160 can cause the third filter-condition data indicating a third specific component of the specific components specified by the user from the second partial configuration-diagram data in a third filter-condition display area 555 in the filter-condition display area 552. When, for example, the user selects the fourteenth function block FB14 and the twenty-ninth function block FB29 from the second partial configuration-diagram data in the configuration-diagram display area 551 with the operation unit 54, the filter-condition display controller 160 can display the third filter-condition data indicating that the third specific component is the fourteenth function block FB14 and the twenty-ninth function block FB29 in the third filter-condition display area 555. In other words, the FA-control program generation support device 100 includes the filter-condition display controller 160 that can include a third filter-condition display controller (not illustrated).

In the FA-control program generation support device 100, the filter-condition acquirer 170 can acquire the third filter-condition data displayed in the third filter-condition display area 555, and store the acquired data into the filter-condition storage 182. In other words, the FA-control program generation support device 100 includes the filter-condition acquirer 170 that can include a third filter-condition acquirer (not illustrated).

In the FA-control program generation support device 100, the relationship analyzer 130 can analyze the relationship between the third specific component and another component different from the third specific component based on the second partial configuration-diagram data and the third filter-condition data. For example, the relationship analyzer 130 can analyze all dependencies associated with the fourteenth function block FB14 as the third specific component, and all dependencies associated with the twenty-ninth function block FB29 as the third specific component, among the dependencies between the component data items ProgPou1 to ProgPou4, ProgPou6 to ProgPou10, ProgPou12, FB6, FB10, FB11, FB14, FB20, FB22, FB25, FB26, and FB29. More specifically, the relationship analyzer 130 can identify the dependency of the sixth function block FB6 on the fourteenth function block FB14, and the dependency of the twenty-sixth function block FB26, the twenty-fifth function block FB25, and the eleventh function block FB11 on the twenty-ninth function block FB29. The relationship analyzer 130 can also identify, for example, the dependency of the second program ProgPou2 and the eighth program ProgPou8 on the sixth function block FB6, and the dependency of the eighth program ProgPou8 on the twenty-sixth function block FB26. In other words, the FA-control program generation support device 100 includes the relationship analyzer 130 that can include a third specific relationship analyzer (not illustrated).

In the FA-control program generation support device 100, the configuration-diagram generator 140 can generate, based on the analysis results from the relationship analyzer 130, third partial configuration-diagram data indicating a third partial configuration diagram that is a part of the second partial configuration diagram including the third specific component and a component associated with the third specific component. For example, the configuration-diagram generator 140 can generate, as the third partial configuration-diagram data, data indicating the third partial configuration diagram including all dependencies associated with the fourteenth function block FB14 and the twenty-ninth function block FB29 each as the third specific component, and can store the generated data into a third partial configuration-diagram storage (not illustrated). In other words, the FA-control program generation support device 100 includes the configuration-diagram generator 140 that can include a third partial configuration-diagram generator (not illustrated).

As illustrated in FIG. 21, in the FA-control program generation support device 100, the configuration-diagram display controller 150 can display the generated third partial configuration-diagram data in the configuration-diagram display area 551. In other words, the FA-control program generation support device 100 includes the configuration-diagram display controller 150 that can include a third partial configuration-diagram display controller (not illustrated).

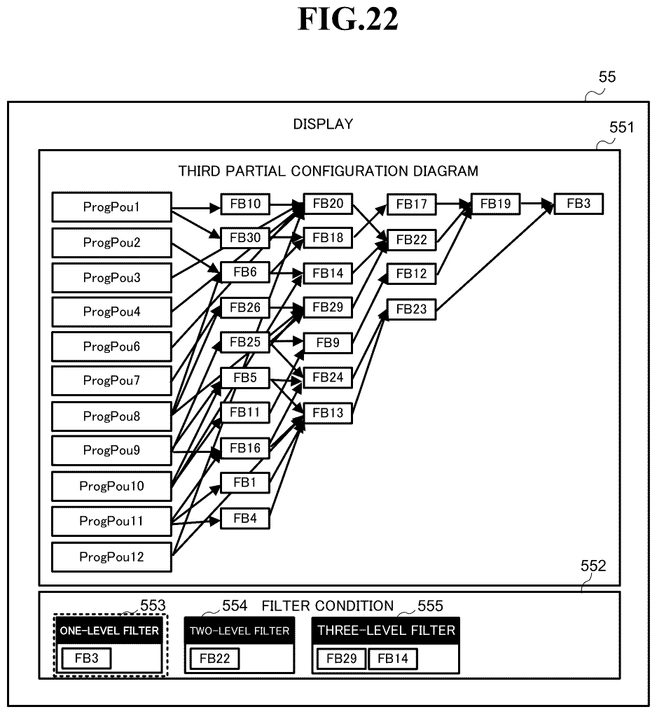

In the FA-control program generation support device 100, when the user selects one of the multiple filter-condition data items displayed in the filter-condition display area 552 with the operation unit 54, the configuration-diagram display controller 150 switches the display of the configuration-diagram display area 551 to the partial configuration-diagram data corresponding to the selected filter condition. For example, the user selects the first filter condition when the third partial configuration-diagram data is displayed in the configuration-diagram display area 551. The configuration-diagram display controller 150 then switches the display of the configuration-diagram display area 551 to the first partial configuration-diagram data as illustrated in FIG. 22.

### FA-Control Program Generation Support Process

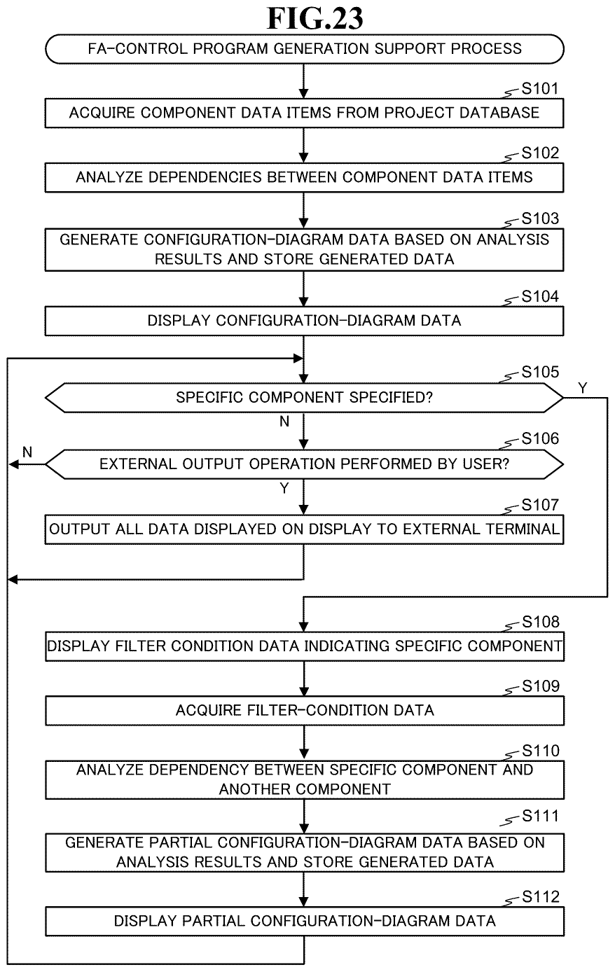

An operation of the FA-control program generation support device 100 for supporting generation of FA-control programs is described with reference to a flowchart. The user performs an operation for activating an FA-control program generation support program using the operation unit 54 with the component data stored in the project database 110. The FA-control program generation support device 100 then starts an FA-control program generation support process illustrated in FIG. 23. First, the component data acquirer 120 acquires the component data items ProgPou1 to ProgPou12 and FB1 to FB30 from the project database 110 (step S101), and the relationship analyzer 130 analyzes the dependencies between the acquired component data items ProgPou1 to ProgPou12 and FB1 to FB30 (step S102).

The configuration-diagram generator 140 then generates and stores configuration-diagram data based on the analysis results (step S103). The configuration-diagram display controller 150 causes display of the generated configuration-diagram data in the configuration-diagram display area 551 (step S104). The filter-condition display controller 160 then determines whether a specific component is specified by the user from the displayed configuration-diagram data (step S105). For example, when the specific component detector 181 detects a specific component based on the text data input by the user, when the specific component changer 184 changes the specific component, or when the user selects any filter-condition data included in the list of filter-condition data displayed by the filter-condition list display controller 183, the filter-condition display controller 160 determines that the specific component is specified.

When the filter-condition display controller 160 determines that no specific component is specified by the user (N in step S105), the external output unit 185 determines whether an external output operation is performed by the user (step S106). When no external output operation is performed by the user (N in step S106), the external output unit 185 returns to step S105 and repeats the processing in steps S105 and S106 until a specific component is specified by the user or an external output operation is performed by the user. When an external output operation is performed by the user (Y in step S106), the external output unit 185 outputs all the data displayed on the display 55 to an external terminal connected to the network (step S107), and returns to step S105.

When a specific component is specified by the user (Y in step S105), the filter-condition display controller 160 causes display of the filter-condition data indicating the specified specific component in the filter-condition display area 552 (step S108). When, for example, the first specific component is specified, the first filter-condition display controller 161 causes display of the first filter-condition data indicating the specified first specific component in the first filter-condition display area 553. When, for example, the second specific component is specified, the second filter-condition display controller 162 causes display of the second filter-condition data indicating the specified second specific component in the second filter-condition display area 554.

The filter-condition acquirer 170 then acquires the filter-condition data displayed in the filter-condition display area 552 (step S109). When, for example, the first specific component is specified, the first filter-condition acquirer 171 acquires the first filter-condition data displayed in the first filter-condition display area 553 together with the configuration-diagram data displayed in the configuration-diagram display area 551. When, for example, the second specific component is specified, the second filter-condition acquirer 172 acquires the second filter-condition data displayed in the second filter-condition display area 554 together with the first partial configuration-diagram data displayed in the configuration-diagram display area 551.

The relationship analyzer 130 then analyzes the dependency between the specific component and another component different from the specific component based on the generated configuration-diagram data and the acquired filter-condition data (step S110). For example, when the first specific component is specified, the first specific relationship analyzer 131 analyzes the relationship between the first specific component and another component different from the first specific component based on the configuration-diagram data and the first filter-condition data. When, for example, the second specific component is specified, the second specific relationship analyzer 132 analyzes the relationship between the second specific component and another component different from the second specific component based on the first partial configuration-diagram data and the second filter-condition data.

The configuration-diagram generator 140 then generates and stores partial configuration-diagram data based on the analysis results (step S111). When, for example, the first specific component is specified, the first partial configuration-diagram generator 141 generates the first partial configuration-diagram data based on the analysis results from the first specific relationship analyzer 131, and stores the first partial configuration-diagram data into the first partial configuration-diagram storage 187 in a manner associated with the first filter-condition data stored in the filter-condition storage 182. When, for example, the second specific component is specified, the second partial configuration-diagram generator 142 generates the second partial configuration-diagram data based on the analysis results from the second specific relationship analyzer 132, and stores the second partial configuration-diagram data into the second partial configuration-diagram storage 188 in a manner associated with the first filter-condition data and the second filter-condition data stored in the filter-condition storage 182.

The configuration-diagram display controller 150 then causes display of the generated partial configuration-diagram data in the configuration-diagram display area 551 (step S112), and returns to step S105. When, for example, the first specific component is specified, the first partial configuration-diagram display controller 151 causes display of the generated first partial configuration-diagram data in the configuration-diagram display area 551. When, for example, the second specific component is specified, the second partial configuration-diagram display controller 152 causes display of the generated second partial configuration-diagram data in the configuration-diagram display area 551.

In the FA-control program generation support device 100 according to the present embodiment, as described above, the component data acquirer 120 acquires the component data from the project database 110, and the relationship analyzer 130 analyzes the relationship between the components based on the component data. The configuration-diagram generator 140 generates configuration-diagram data based on the analysis results, and the configuration-diagram display controller 150 causes the display 55 to display the configuration-diagram data. The first filter-condition acquirer 171 also acquires the first filter-condition data specified by the user from the configuration-diagram data.

The first partial configuration-diagram generator 141 generates the first partial configuration-diagram data based on the configuration-diagram data and the first filter-condition data, and the first partial configuration-diagram display controller 151 causes the display 55 to display the first partial configuration-diagram data. The second filter-condition acquirer 172 also acquires the second filter-condition data specified by the user from the first partial configuration-diagram data. The second partial configuration-diagram generator 142 then generates the second partial configuration-diagram data based on the first partial configuration-diagram data and the second filter-condition data, and the second partial configuration-diagram display controller 152 causes the display 55 to display the second partial configuration-diagram data.

In this manner, the FA-control program generation support device 100 according to the present embodiment can identify the dependencies between multiple types of components specified under multilevel filter conditions and other components.

Thus, the FA-control program generation support device 100 according to the present embodiment allows the user to more easily identify components associated with specific components than an FA-control program generation support device that does not allow the user to specify the second specific component from the first partial configuration-diagram data and than an FA-control program that does not generate or display the second partial configuration-diagram data when the second specific component is specified by the user. The FA-control program generation support device 100 according to the present embodiment thus allows the user to easily identify the range of influences caused by a change in a specific component, reducing the work-hours for debugging the FA-control program and the work-hours for programming.

In the FA-control program generation support device 100 according to the present embodiment, the first filter-condition display controller 161 causes the display 55 to display the first filter-condition data when the user specifies the first filter-condition data from the configuration-diagram data. The second filter-condition display controller 162 causes the display 55 to display the second filter-condition data when the user specifies the second filter-condition data from the first partial configuration-diagram data.

Thus, the FA-control program generation support device 100 according to the present embodiment displays multilevel filter conditions and allows the user to check the filter conditions specified based on the user input. Thus, the FA-control program generation support device 100 according to the present embodiment allows the user to more easily check multilevel filter conditions specified by the user than an FA-control program generation support device that does not display all specified filter-condition data.

In the FA-control program generation support device 100 according to the present embodiment, the specific component detector 181 detects the first specific component based on text data input by the user when the configuration-diagram data is displayed. The specific component detector 181 detects the second specific component based on text data input by the user when the first partial configuration-diagram data is displayed.

Thus, the FA-control program generation support device 100 according to the present embodiment allows the user to more promptly specify a specific component than an FA-control program generation support device that cannot detect a specific component based on text data input by the user, improving the efficiency of search for the range of influences caused by a change in a specific component. The FA-control program generation support device 100 according to the present embodiment thus allows the user to more easily identify the range of influences caused by a specific component, further reducing the work-hours for debugging the FA-control program and the work-hours for programming.

In the FA-control program generation support device 100 according to the present embodiment, the filter-condition storage 182 stores the filter-condition data including the first filter-condition data and the second filter-condition data. The filter-condition list display controller 183 causes the display 55 to display a list of filter-condition data stored in the filter-condition storage 182. The first filter-condition display controller 161 causes the display 55 to display, as the first filter-condition data, the data selected by the user from the list of filter-condition data as the first specific component. The second filter-condition display controller 162 causes the display 55 to display, as the second filter-condition data, the data selected by the user from the list of filter-condition data as the second specific component.

Thus, the FA-control program generation support device 100 according to the present embodiment can display a list of filter-condition data generated in the past to allow the user to select filter-condition data, and can display partial configuration-diagram data generated in the past again. The FA-control program generation support device 100 according to the present embodiment thus allows the user to specify a specific component more easily than an FA-control program generation support device that cannot allow the user to select filter-condition data generated in the past, improving the efficiency of search for the range of influences caused by a change in a specific component. The FA-control program generation support device 100 according to the present embodiment thus allows the user to more easily identify the range of influences caused by a change in a specific component, further reducing the work-hours for debugging the FA-control program and the work-hours for programming.

In the FA-control program generation support device 100 according to the present embodiment, the specific component changer 184 changes the first specific component based on the text data input by the user when the first filter-condition data is displayed. The first filter-condition display controller 161 then causes the display 55 to display the input text data as first filter-condition data indicating the first specific component changed by the user. The specific component changer 184 changes the second specific component based on the text data input by the user when the second filter-condition data is displayed. The second filter-condition display controller 162 then causes the display 55 to display the input text data as second filter-condition data indicating the second specific component changed by the user.

Thus, the FA-control program generation support device 100 according to the present embodiment allows the user to edit the filter-condition data generated in the past. The FA-control program generation support device 100 according to the present embodiment thus allows the user to easily specify a specific component than an FA-control program generation support device that cannot allow the user to edit the filter-condition data generated in the past, improving the efficiency of search for the range of influences caused by a change in a specific component. The FA-control program generation support device 100 according to the present embodiment thus allows the user to more easily identify the range of influences caused by a change in a specific component, further reducing the work-hours for debugging the FA-control program and the work-hours for programming.

In the FA-control program generation support device 100 according to the present embodiment, the external output unit 185 outputs data displayed on the display 55 to an external device.

Thus, the FA-control program generation support device 100 according to the present embodiment allows a user of an external terminal, or a third party, to easily refer to configuration diagrams, specific components, and the range of influences caused by a change in a specific component than an FA-control program generation support device that does not output data to an external device.

### Modifications

Although the FA-control program generation support device 100 according to the above embodiment displays the partial configuration-diagram data under three filter conditions as illustrated in FIG. 21, the number of filter conditions is not limited to this example. The FA-control program generation support device 100 may display the partial configuration-diagram data under any number of one or more filter conditions. For example, the FA-control program generation support device 100 may generate and display partial configuration-diagram data under five filter conditions. More specifically, the FA-control program generation support device 100 may be a multilevel filter with any levels of filters. The FA-control program generation support device 100 may not be a three-level filter in the embodiment, and may be, for example, a five-level filter.

Although two components are specified as the third specific component as illustrated in FIG. 21, the FA-control program generation support device 100 according to the above embodiment may specify the first specific component and the second specific component in the same manner. Two components may be specified as the first specific component and two components may be specified as the second specific component. Instead of two components being specified, any number of components other than two components may be specified. For example, five components may be specified as the first specific component, three components may be specified as the second specific component, or one component may be specified as the third specific component. When two or more components are specified as these specific components, the specified two or more components are analyzed under OR conditions. However, the specified two or more components may be analyzed under AND conditions. In this case, two or more components specified as specific components based on data input by the user are to be set under OR conditions or AND conditions.

Although the FA-control program generation support device 100 according to the above embodiment acquires the component data of each program and each function block from the project database 110, the FA-control program generation support device 100 may acquire other data such as component data of structures or component data of interfaces. In this case, the dependencies between the components in the program, function blocks, structures, and interfaces may be analyzed for generating and displaying the configuration-diagram data. The user can specify a specific component from the component data of programs, function blocks, structures, and interfaces.

As illustrated in FIG. 9, the FA-control program generation support device 100 according to the above embodiment detects new first specific components when the user inputs text data in the first filter-condition display area 553 with the configuration-diagram data being displayed, and detects new second specific components when the user inputs text data in the second filter-condition display area 554 with the first partial configuration-diagram data being displayed as illustrated in FIG. 15. However, the embodiment is not limited to this structure. For example, the FA-control program generation support device 100 may detect any new first specific component when the user inputs text data into the first filter-condition display area 553 with the second partial configuration-diagram data or the third partial configuration-diagram data being displayed.

In this case, the FA-control program generation support device 100 is to retry analysis of the specific components subsequent to the detected new first specific component and to retry generation and display of the partial configuration-diagram data subsequent to the first partial configuration-diagram data, although the remaining specific components subsequent to the second specific component are unchanged. When the new first specific component has no dependency on other unchanged specific components after the change to the new first specific component, the FA-control program generation support device 100 may display, without the change to the new first specific component, an alert message indicating that such a change can cause no dependency on the other specific components and cause failure to generate partial configuration-diagram data, or may change the first specific component to the new first specific component and retry any possible analysis of the specific component and generation and display of the partial configuration-diagram data.

Although the FA-control program generation support device 100 according to the above embodiment analyzes the dependencies between the components, the embodiment is not limited to this example and may analyze other relationships. For example, the FA-control program generation support device 100 may analyze the relationship between the components using the same global variable. For example, when the FA-control program is described under object-oriented concepts, the FA-control program generation support device 100 may analyze the relationship in which one component inherits another component.

The FA-control program generation support device 100 including the controller 51, the main storage 52, the external storage 53, the operation unit 54, the transmitter-receiver 56, the internal bus 50, and other components to perform the processes may be mainly implemented by, for example, an FA-control program generation support program for performing the above operations stored and distributed in a non-transitory recording medium such as a flash memory readable by the FA-control program generation support device 100. The FA-control program generation support program may be installed to provide the FA-control program generation support device 100 that performs the above processes. The FA-control program generation support program may be stored in a storage device in a server on a communication network, such as a local area network (LAN) or the Internet, and downloaded to be used by the FA-control program generation support device 100 to provide the FA-control program generation support device 100.

For the functions of the FA-control program generation support device 100 implementable by a shared operation of an operating system (OS) and an application program or through cooperation between the OS and the application program, portions executable by the application program may be stored in a non-transitory recording medium or a storage.

The FA-control program generation support program may be superimposed on a carrier wave to be provided through a communication network. For example, the FA-control program generation support program may be posted on a bulletin board system (BBS) on the communication network to be provided through the network. The FA-control program generation support program may be activated and executed under the control of the OS in the same manner as other application programs to perform the above processing.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Reference Signs List

50 Internal bus
51 Controller
52 Main storage
53 External storage
54 Operation unit
55 Display
56 Transmitter-receiver
59 Control program
100 FA-control program generation support device
110 Project database
120 Component data acquirer
130 Relationship analyzer
131 First specific relationship analyzer
132 Second specific relationship analyzer
140 Configuration-diagram generator
141 First partial configuration-diagram generator
142 Second partial configuration-diagram generator
150 Configuration-diagram display controller
151 First partial configuration-diagram display controller
152 Second partial configuration-diagram display controller
160 Filter-condition display controller
161 First filter-condition display controller
162 Second filter-condition display controller
170 Filter-condition acquirer
171 First filter-condition acquirer
172 Second filter-condition acquirer
181 Specific component detector
182 Filter-condition storage
183 Filter-condition list display controller
184 Specific component changer
185 External output unit
186 Configuration-diagram storage
187 First partial configuration-diagram storage
188 Second partial configuration-diagram storage
551 Configuration-diagram display area
552 Filter-condition display area
553 First filter-condition display area
554 Second filter-condition display area
555 Third filter-condition display area

1. A non-transitory computer-readable recording medium storing an FA-control program generation support program causing a computer to execute processing:
acquiring component data stored in a database for a project to manage data for an FA-control program, the component data being data about a component of the project, the FA-control program being a structured program executable by a programmable logic controller to control an FA device, the FA being factory automation;
analyzing a relationship between components of the project data based on the component data:
generating, based on a result of the analysis of the relationship between the components of the project, configuration-diagram data, the configuration-diagram data indicating a configuration diagram of the project;
causing a display to display the configuration-diagram data;
acquiring first filter-condition data, the first filter-condition data indicating a first specific component of the project specified by a user from the configuration-diagram data;
generating first partial configuration-diagram data based on the configuration-diagram data and the first filter-condition data, the first partial configuration-diagram data indicating a first partial configuration diagram being a part of the configuration diagram including the first specific component and a component associated with the first specific component;
causing the display to display the first partial configuration-diagram data;
acquiring second filter-condition data, the second filter-condition data indicating a second specific component of the project specified by the user from the first partial configuration-diagram data;
generating second partial configuration-diagram data based on the first partial configuration-diagram data and the second filter-condition data, the second partial configuration-diagram data indicating a second partial configuration diagram being a part of the first partial configuration diagram including the second specific component and a component associated with the second specific component; and
causing the display to display the second partial configuration-diagram data.

2. The non-transitory computer-readable recording medium according to claim 1, wherein the program further causes the computer to execute processing comprising
causing the display to display the first filter-condition data, and
causing the display to display the second filter-condition data.

3. The non-transitory computer-readable recording medium according to claim 1, wherein the program further causes the computer to execute processing comprising
detecting the first specific component based on text data input by the user when the configuration-diagram data is displayed, and detecting the second specific component based on text data input by the user when the first partial configuration-diagram data is displayed.

4. The non-transitory computer-readable recording medium according to claim 2, wherein the program further causes the computer to execute processing comprising
storing filter-condition data including the first filter-condition data and the second filter-condition data,
causing the display to display a list of the filter-condition data stored in the filter-condition storage,
causing the display to display the first filter-condition data selected by the user from the displayed list of the first filter-condition data, and
causing the display to display the second filter-condition data selected by the user from the displayed list of the second filter-condition data.

5. The non-transitory computer-readable recording medium according to claim 2, wherein the program further causes the computer to execute processing comprising
changing the first specific component based on data input by the user when the first filter-condition data is displayed, and changing the second specific component based on data input by the user when the second filter-condition data is displayed,
causing wherein the display to display the first filter-condition data indicating the first specific component changed by the user, and
causing the display to display the second filter-condition data indicating the second specific component changed by the user.

6. The non-transitory computer-readable recording medium according to claim 2, wherein the program further causes the computer to execute processing comprising
outputting data displayed on the display to an external device.

7. An FA-control program generation support device for supporting generation of an FA-control program, the FA-control program being a structured program executable by a programmable logic controller to control an FA device, the FA being factory automation, the device comprising:
processing circuitry; and
a display, wherein
the processing circuitry
acquires component data stored in a database for a project to manage data for the FA-control program, the component data being data about a component of the project,
analyzes a relationship between components of the project data based on the component data.
generates, based on a result of the analysis of the relationship between the components of the project, configuration-diagram data, the configuration-diagram data indicating a configuration diagram of the project,
causes the display to display the configuration-diagram data,
causes the display to display filter-condition data, the filter-condition data indicating a specific component of the project specified by a user from the configuration-diagram data,
acquires the filter-condition data,
acquires first filter-condition data, the first filter-condition data being the filter-condition data indicating a first specific component of the project specified by the user from the configuration-diagram data,
generates first partial configuration-diagram data based on the configuration-diagram data and the first filter-condition data, the first partial configuration-diagram data indicating a first partial configuration diagram being a part of the configuration diagram including the first specific component and a component associated with the first specific component,
causes the display to display the first partial configuration-diagram data,
acquires second filter-condition data, the second filter-condition data being the filter-condition data indicating a second specific component of the project specified by the user from the first partial configuration-diagram data,
generates second partial configuration-diagram data based on the first partial configuration-diagram data and the second filter-condition data, the second partial configuration-diagram data indicating a second partial configuration diagram being a part of the first partial configuration diagram including the second specific component and a component associated with the second specific component, and
causes the display to display the second partial configuration-diagram data.

8. An FA-control program generation support method for supporting generation of an FA-control program, the FA-control program being a structured program executable by a programmable logic controller to control an FA device, the FA being factory automation, the method comprising:
acquiring, with a computer, component data stored in a database for a project to manage data for the FA-control program, the component data being data about a component of the project;
analyzing, with the computer, a relationship between components of the project data based on the component data;
generating, with the computer, configuration-diagram data based on a result of the analysis of the relationship between the components of the project, the configuration-diagram data indicating a configuration diagram of the project;
causing, with the computer, a display to display the configuration-diagram data;
acquiring, with the computer, first filter-condition data, the first filter-condition data indicating a first specific component of the project specified by a user from the configuration-diagram data;
generating, with the computer, first partial configuration-diagram data based on the configuration-diagram data and the first filter-condition data, the first partial configuration-diagram data indicating a first partial configuration diagram being a part of the configuration diagram including the first specific component and a component associated with the first specific component;
causing, with the computer, the display to display the first partial configuration-diagram data;
acquiring, with the computer, second filter-condition data, the second filter-condition data indicating a second specific component of the project specified by the user from the first partial configuration-diagram data;
generating, with the computer, second partial configuration-diagram data based on the first partial configuration-diagram data and the second filter-condition data, the second partial configuration-diagram data indicating a second partial configuration diagram being a part of the first partial configuration diagram including the second specific component and a component associated with the second specific component; and
causing, with the computer, the display to display the second partial configuration-diagram data.
